(19) United States
(12) Patent Application Publication
(10) Pub. No.: US 2023/0226486 A1
(43) Pub. Date: Jul. 20, 2023

(54) METHODS FOR CARBON DIOXIDE CAPTURE AND RELATED SYSTEMS

(71) Applicants: Battelle Energy Alliance, LLC, Idaho Falls, ID (US); Kansas State University Research Foundation, Manhattan, KS (US)

(72) Inventors: Dong Ding, Idaho Falls, ID (US); Wei Wu, Idaho Falls, ID (US); Chuancheng Duan, Manhattan, KS (US)

(21) Appl. No.: 18/156,626

(22) Filed: Jan. 19, 2023

Related U.S. Application Data
(60) Provisional application No. 63/266,919, filed on Jan. 19, 2022.

(51) Int. Cl. B01D 53/32; H01M 8/14; H01M 8/0656; H01M 8/04007

(52) U.S. Cl. CPC B01D 53/326; H01M 8/145; H01M 8/0656; H01M 8/04007; H01M 2008/147

(57) ABSTRACT

A method for capturing carbon dioxide comprises introducing a first feed stream comprising carbon dioxide and dioxygen into a first electrochemical cell, reducing the carbon dioxide to carbonate ions at a first cathode of the first electrochemical cell, and reducing the carbonate ions at a first anode to produce a first product stream comprising concentrated carbon dioxide and a second product stream comprising water. A second feed stream comprising water is introduced to a second electrochemical cell coupled to the first electrochemical cell. The water is oxidized at a second anode of the second electrochemical cell to produce hydrogen ions and dioxygen gas, the hydrogen ions are reduced to hydrogen gas at a second cathode, and the hydrogen gas produced by the second cathode is transported to the first anode. The first product stream is removed from the first electrochemical cell. Additional methods and related systems are also disclosed.

### CROSS-REFERENCE TO RELATED APPLICATION

This application claims the benefit under 35 U.S.C. § 119(e) of U.S. Provisional Patent Application Ser. No. 63/266,919, filed Jan. 19, 2022, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the disclosure relate to methods and systems for carbon capture. Certain embodiments relate to a multimodal device capable of capturing carbon dioxide and oxidizing water for an efficient way to capture carbon dioxide.

### BACKGROUND

Increases in global energy demand have led to increases in the combustion of fossil fuels, leading to a concomitant increase in carbon dioxide (CO₂) emissions. Concerns over potential adverse effects on the environment due to the presence of CO₂ in the atmosphere have driven efforts to capture, sequester, and/or convert CO₂ from the atmosphere into other chemicals (e.g., formic acid).

Carbon dioxide capture methods generally proceed by either (1) absorbing CO₂ into a material or medium, or (2) adsorbing CO₂ onto a material (e.g., zeolites, graphene, carbon nanotubes, ordered mesoporous silica, metal-organic frameworks (or “MOFs”), etc.).

A current method for capturing CO₂ uses amine-based absorbents, such as monoethanolamine (MEA), to chemically bind CO₂ followed by a regeneration step to release CO₂. MEA-mediated CO₂ capture occurs by reacting a primary amine (i.e., —NH₂) with CO₂ to form a zwitterionic —NH₂CO₂ group (or MEA-CO₂). The CO₂ may be separated in the regeneration step, which requires significant energy (e.g., roughly 3.22 GJ per kg of CO₂ to release) to decarboxylate MEA-CO₂ to regenerate the original MEA and free CO₂.

Electrochemical CO₂ capture methods have emerged as an additional tool for direct air capture (DAC) of CO₂ and also CO₂ extraction from seawater. In aqueous electrochemical cells (i.e., electrochemical cells that use aqueous electrolytes), redox-active carriers may selectively react with CO₂ at one electrode, transport (e.g., shuttle) CO₂ through an aqueous electrolyte solution to the other electrode, where CO₂ may be electrochemically released from the redox-active carrier. For example, quinone can be used as a redox-active carrier that captures CO₂ in an aqueous electrochemical cell. In addition, molten carbonate fuel cell (MCFCs) have been used for carbon capture and shown to remove >95% of the CO₂ from cathode streams with a low concentration of CO₂ (Rosen et al. (2020) J. Electrochem. Soc. 167(6):064505).

### BRIEF SUMMARY

A method of capturing carbon dioxide from a feed stream is disclosed and comprises introducing a first feed stream comprising carbon dioxide and dioxygen into a first electrochemical cell; reducing the carbon dioxide to carbonate ions at a first cathode of the first electrochemical cell; reducing the carbonate ions at a first anode of the first electrochemical cell to produce a first product stream comprising concentrated carbon dioxide and a second product stream comprising water; introducing a second feed stream comprising water to a second electrochemical cell coupled to the first electrochemical cell; oxidizing the water of the second feed stream at a second anode of the second electrochemical cell to produce hydrogen ions and dioxygen gas; reducing the hydrogen ions to hydrogen gas at a second cathode of the second electrochemical cell; transporting the hydrogen gas produced by the second cathode of the second electrochemical cell to the first anode of the first electrochemical cell; and removing the first product stream from the first electrochemical cell.

Another method for capturing carbon dioxide is disclosed and includes introducing a first feed stream comprising air into a molten carbonate fuel cell maintained at a temperature of from about 500° C. to about 700° C.; reducing carbon dioxide from the air to carbonate ions at a cathode of the molten carbonate fuel cell; transporting the carbonate ions through an electrolyte of the molten carbonate fuel cell; reducing the carbonate ions at an anode of the molten carbonate fuel cell to produce a first product stream comprising carbon dioxide and a second product stream comprising water; introducing the second product stream comprising water to a proton conducting electrolyzer coupled to the molten carbonate fuel cell and maintained at a temperature of from about 500° C. to about 700° C.; oxidizing the water of the second product stream at an anode of the proton conducting electrolyzer to produce hydrogen ions and dioxygen gas; transporting the hydrogen ions through an electrolyte of the proton conducting electrolyzer; reducing the hydrogen ions to hydrogen gas at a cathode of the proton conducting electrolyzer; transporting the hydrogen gas to the anode of the molten carbonate fuel cell; and recovering the first product stream from the molten carbonate fuel cell.

A system for capturing carbon dioxide is also disclosed and comprises at least one first electrochemical cell coupled to at least one second electrochemical cell. The at least one first electrochemical cell includes a first cathode formulated to oxidize a first feed stream comprising carbon dioxide and dioxygen to carbonate ions; and a first anode formulated to reduce the carbonate ions to carbon dioxide and water. The at least one second electrochemical cell includes a second anode formulated to oxidize a second feed stream comprising water to hydrogen ions and dioxygen gas, and a second cathode formulated to reduce the hydrogen ions into hydrogen gas. The system is configured to supply the hydrogen ions produced by the second cathode of the at least one second electrochemical cell to the first anode of the at least one first electrochemical cell.

### BRIEF DESCRIPTION OF THE DRAWINGS

FIG. 1 is an illustration of a system in accordance with embodiments of the disclosure;

FIG. 2 is an illustration of a system in accordance with embodiments of the disclosure;

FIG. 3 is an illustration of a multicomponent device including the system in accordance with embodiments of the disclosure;

FIG. 4 shows the performance of a molten carbonate fuel cell (MCFC) as a function of target CO₂ capture at different cathode CO₂ concentrations. Experiments in this figure were conducted at a current density of 90 mA cm⁻²;

FIG. 5 shows the performance of a molten carbonate fuel cell (MCFC) as a function of varying water contents. Experiments in this figure were conducted at a current density of 90 mA cm⁻²;

FIG. 6 shows j-V curves and H₂ production rates of a proton conducting electrolyzer (PCE) as a function of current density under electrolysis mode operation;

FIGS. 7A and 7B show the long-term durability of a PCE in electrolysis mode based on H₂ production rate (FIG. 7A) and electrochemical impedance spectroscopy (FIG. 7B); and

FIG. 8 depicts an Aspen-HYSYS model of a system in accordance with embodiments of the disclosure.

### DETAILED DESCRIPTION

Methods and systems for capturing and concentrating CO₂ from a source stream, such as ambient air, are disclosed. The systems and methods enable the concentration of CO₂ from the source stream by converting CO₂ into carbonate ions and subsequently converting the carbonate ions back to CO₂ in a first product stream. The system comprises a first electrochemical cell and a second electrochemical cell. The first electrochemical cell is configured to selectively convert CO₂ in a first feed stream. The second electrochemical cell is configured to generate hydrogen gas (H₂) from water oxidation. The hydrogen gas migrates to the first electrochemical cell, where the hydrogen gas undergoes oxidation to produce water, and carbonate ions are reduced (e.g., chemically reduced) to produce CO₂. The system may continuously capture and concentrate CO₂ at intermediate temperatures, such as a temperature of from about 500° C. to about 700° C.

The following description provides specific details, such as material compositions and processing conditions (e.g., temperatures, pressures, flow rates, etc.) in order to provide a thorough description of embodiments of the disclosure. However, a person of ordinary skill in the art will understand that the embodiments of the disclosure may be practiced without using these specific details. Indeed, the embodiments of the disclosure may be practiced in conjunction with conventional systems and methods used in the industry. In addition, only those components and acts necessary to understand the embodiments of the disclosure are described in detail. A person of ordinary skill in the art will understand that some components may not be described herein but that using various conventional components and acts would be in accord with the disclosure. Any drawings accompanying the present disclosure are for illustrative purposes only and are not necessarily drawn to scale. Elements common among figures may retain the same numerical designation.

As used herein, spatially relative terms, such as “adjacent,” “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “configured” refers to a size, shape, material composition, and arrangement of one or more of at least one structure and at least one apparatus facilitating operation of one or more of the structure and the apparatus in a pre-determined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” or “approximately” in reference to a numerical value for a given parameter is inclusive of the numerical value and has the meaning dictated by the context (e.g., it includes the degree of error associated with measurement of the given parameter). For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “electrode” means and includes a conductor having a relatively lower potential in an electrochemical cell (i.e., lower than the potential in a positive conductor therein) or a conductor having a relatively higher potential in an electrochemical cell (i.e., higher than the potential in a negative conductor therein).

As used herein, the terms “catalyst material” and “catalyst” and their grammatical equivalents each mean and include a material formulated to promote one or more reactions, resulting in the formation of a product.

As used herein, the term “negative electrode” and grammatical equivalents means and includes an electrode having a relatively lower electrode potential in an electrochemical cell (e.g., lower than the electrode potential in a positive electrode therein). The negative electrode means and includes a cathode.

Conversely, as used herein, the term “positive electrode” and grammatical equivalents means and includes an electrode having a relatively higher electrode potential in an electrochemical cell (e.g., higher than the electrode potential in a negative electrode therein). The positive electrode means and includes an anode.

As used herein, the term “electrolyte” and grammatical equivalents means and includes an ionic conductor, which can be in a solid state, a liquid state, or a gaseous state (e.g., plasma).

As used herein, the term “eutectic” means and includes a mixture of at least two solids that dissolve in each other at a particular temperature. For example, a eutectic mixture of 62 mol % Li₂CO₃ and 38 mol % K₂CO₃ dissolves at about 650° C.

As used herein, the term “foam” means and includes a material having pores. The material constituting the foam may comprise a metal or a polymeric material. The metal may be a single metal or a multi-metal mixture (e.g., a binary mixture or other alloy). The foam may be an open-cell foam, a closed-cell foam, a stochastic foam, or a so-called “regular foam.” A “regular foam” means and includes a porous material, where the pores (or “cells”) are homogeneously dispersed throughout the material.

As used herein, the term “porosity” means and includes the ratio between the void volume (Vᵥ) and the total volume (Vₜₒₜ) of a material. Multiplying the ratio by 100 gives the porosity as a percentage.

As used here, the term “atomic composition” or “atomic percent” or “atomic %” means and includes the relative proportion of a chemical element relative to the total chemical composition.

As used herein, the term “molten-carbonate fuel cell” or “MCFC” means and includes a high-temperature fuel cell that operates at temperatures above about 500° C. The MCFC uses an electrolyte composed of a molten carbonate salt mixture suspended in a ceramic matrix solid electrolyte which is chemically inert and porous.

As used herein, “proton conducting electrolyzer” or “PCE” means and includes a fuel cell or electrolysis cell that operates at intermediate temperature, such as between about 250° C. and about 600° C. The PCE may be used in reversible conversions between chemical and electrical energy with high efficiency and zero emissions.

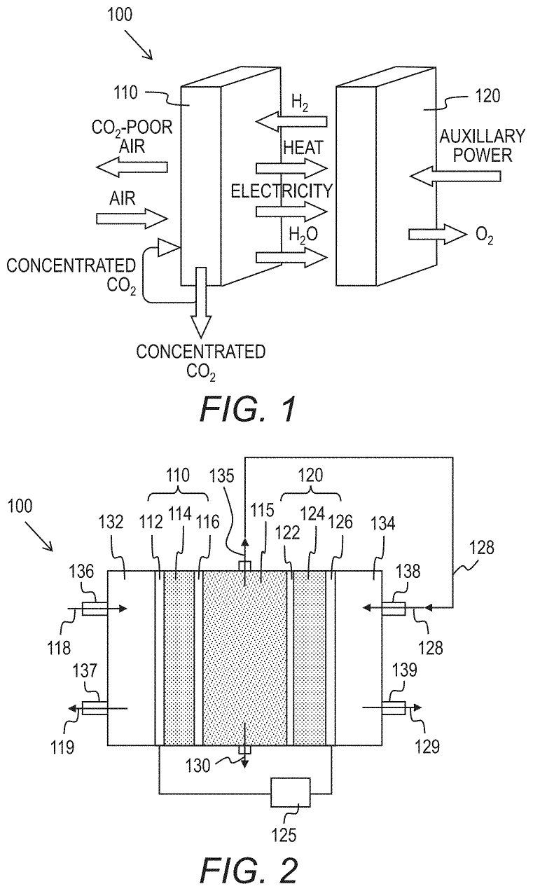

With reference to FIG. 1, a system 100 for capturing CO₂ includes a first electrochemical cell 110 and a second electrochemical cell 120. The first electrochemical cell 110 continuously captures CO₂ from the source stream, such as air (e.g., ambient air, atmospheric air), and substantially simultaneously generates electricity, heat, and H₂O. The second electrochemical cell 120 subsequently uses the electricity, heat, and H₂O for producing H₂ via water electrolysis, and the H₂ is then transported (e.g., fed) to the first electrochemical cell 110 to drive CO₂ capture. Thus, H₂O produced in the first electrochemical cell 110 is used for H₂ production in the second electrochemical cell 120, and there is net-zero water consumption. Advantageously, the system 100 couples an endothermic second electrochemical cell 120 and an exothermic first electrochemical cell 110, which creates a spatially uniform, thermally balanced operation inside the system 100, resulting in a simplified system with minimized power and heat consumption.

As more specifically illustrated in FIG. 2, the system 100 may include the first electrochemical cell 110, the second electrochemical cell 120, and an interconnect material 115 interposed between the first electrochemical cell 110 and the second electrochemical cell 120. The first electrochemical cell 110 comprises a first cathode 112, a first anode 116, and a first electrolyte 114 interposed between the first cathode 112 and the first anode 116. The second electrochemical cell 120 comprises a second cathode 122, a second anode 126, and a second electrolyte 124 interposed between the second cathode 122 and the second anode 126. The interconnect material 115 is adjacent to the first anode 116 of the first electrochemical cell 110 and the second cathode 122 of the second electrochemical cell 120.

The system 100 produces two streams: the first product stream 130, which includes concentrated CO₂, and the second product stream 135, which includes water. In some embodiments, the concentrated CO₂ may be transported to other components associated with the system 100 for downstream conversion to desirable products such as carbon monoxide, formic acid, acetic acid, or other carbon-containing compounds. In other embodiments, the second product stream 135 may be transported to the second electrochemical cell 120 as a second feed stream 128 to provide a closed-loop, continuous system for producing H₂ gas from water. Thus, the system 100 may use a constant and single source for hydrogen ions for the conversion of carbonate into CO₂.

The first electrochemical cell 110 and the second electrochemical cell 120 are electrically coupled to a power source 125, which may be powered by an alternative energy source (e.g., wind power, solar power, geothermal energy, hydroelectricity, nuclear energy, etc.). A voltage of from about 0.7 V to about 1.0 V may be applied to the first electrochemical cell 110 and the second electrochemical cell 120 from the power source 125. During use and operation, the first electrochemical cell 110 may generate sufficient thermal energy to help drive (e.g., increase) catalysis at the second electrochemical cell 120, and the interconnect material 115 may transfer thermal energy produced at the first electrochemical cell 110 to the second electrochemical cell 120. The additional thermal input lowers the activation energy to drive the reactions at the second electrochemical cell 120, reducing an applied over potential to the second electrochemical cell 120. Using thermal “waste” produced by the reactions occurring at the first electrochemical cell 110 beneficially lowers the overall energetic input for operating the system 100. Additionally, the first anode 116 of the first electrochemical cell 110 generates the electrons for the reduction reaction at the second cathode 122 of the second electrochemical cell 120.

The first electrochemical cell 110 may be adjacent to a first headspace 132 of the system 100. The first headspace 132 is coupled to a first inlet 136 that enables the inward flow of a first feed stream 118 (e.g., the source stream), which includes water and dilute CO₂. The first headspace 132 is also coupled to a first outlet 137 that transports the first output stream 119 away from the system 100, the first output stream 119 being substantially free of CO₂.

The first electrochemical cell 110 may be configured to selectively convert CO₂ (from the first feed stream 118) into carbonate ions at the first cathode 112. In certain embodiments, the first electrochemical cell 110 exhibits at least about 80%, at least about 85%, at least about 90%, or at least about 95% selectivity for CO₂ as compared to other gases such as water or N₂.

The first feed stream 118 introduced to the first electrochemical cell 110 of the system 100 may be a dilute CO₂-containing feed stream that contains less than about 1200 parts per million (ppm) of the CO₂. The first feed stream 118 may include from about 200 ppm to about 1200 ppm CO₂, such as from about 300 ppm to about 1000 ppm CO₂, from about 400 ppm to about 800 ppm CO₂, from about 500 ppm to about 700 ppm CO₂, from about 600 ppm to about 700 ppm CO₂, from about 350 ppm to about 600 ppm CO₂, from about 400 ppm to about 1000 ppm CO₂, or from about 400 ppm to about 500 ppm CO₂. The components of the first electrochemical cell 110 (e.g., the first cathode 112, the first anode 116, the first electrolyte 114) may exhibit sufficient porosity to allow for gas transport through the first electrochemical cell 110 and conversion into different products.

In addition to CO₂, the first feed stream 118 may include other components, such as other gaseous components. The first feed stream 118 may be an air feed stream (e.g., an atmospheric air feed stream, an ambient air feed stream), which includes the CO₂, nitrogen, oxygen, and other gases, with the nitrogen and oxygen being present at a relatively greater amount relative to the CO₂ and the other components. For example, the CO₂ may be present in the air feed stream at about 0.04% by volume. The first feed stream 118 may also include water, such as at from about 0.1% by volume to about 5.0% by volume of water. However, the first feed stream 118 may include a relatively higher or relatively lower amount of CO₂ or of water depending on the source of the air feed stream. The air feed stream may, therefore, have a variable composition. For instance, the air feed stream from a more humid location on Earth may include a relatively higher amount of water than the air feed stream from a drier location on Earth. In some embodiments, the first feed stream 118 is atmospheric air. While the first feed stream 118 may be an air feed stream, the first feed stream 118 may be a more concentrated CO₂-containing feed stream, such as containing CO₂ at greater than or equal to about 1000 ppm. By way of example only, the first feed stream 118 may include the CO₂ at greater than about 10% by volume. For example, the first feed stream 118 may be a CO₂-containing feed stream from a coal fired power plant or from an ethanol fermenter.

The first electrochemical cell 110 may be a molten carbonate fuel cell (MCFC) configured to selectively convert CO₂ into carbonate ions at the first cathode 112. The first electrochemical cell 110 is configured to interact with the first feed stream 118 comprising CO₂ and dioxygen, where the first feed stream 118 interacts with the first cathode 112 of the first electrochemical cell 110. The first cathode 112 selectively converts the CO₂ and dioxygen into carbonate ions (CO₃²) according to the following reaction:

$${CO}_{2} + \frac{1}{2} {O}_{2} + 2 {e}^{-} \to {CO}_{3}^{2 -} \qquad ( 1 )$$

The produced carbonate ions diffuse through the first electrolyte 114 and to the first anode 116, while the first feed stream 118 becomes CO₂-poor and leaves the first electrochemical cell 110 as a first output stream 119. The first output stream 119 includes unreacted gases and side products from the reaction at the first cathode 112. The first anode 116 produces a first product mixture by catalyzing the following reaction:

CO₃²⁻+H₂→CO₂+H₂O+2e⁻ (2)

The first product mixture may be separated into a first product stream 130 comprising concentrated CO₂ and a second product stream 135 comprising water. The second product stream 135 may be used in (e.g., fed into) the second electrochemical cell 120 as the second feed stream 128.

The first cathode 112 may be formed of and include a lithiated catalytic species on a cathode support that includes a metal oxide, a metal-based cermet, lanthanum strontium manganite (LSM), lanthanum strontium cobalt ferrite, or doped variants. The first cathode 112 may be formed (e.g., deposited) according to methods known in the art, such as, but not limited to, Physical Vapor Deposition (PVD), Chemical Vapor Deposition (CVD), Atomic Layer Deposition (ALD), Plasma Enhanced Chemical Vapor Deposition (PECVD), sintering, or tape-casting. The cathode support may be nickel oxide (i.e., NiO). The catalytic species is formulated to catalyze the reaction of CO₂ to form carbonate ions. In some embodiments, lithium may be intercalated into a NiO matrix by lithiating the NiO. The lithiated NiO may be produced by ball milling, sintering, co-precipitation, solid-state reactions, forming a sol-gel, the Pechini method, hydrothermal methods, electrochemical deposition, or a combination thereof. In some embodiments, the first electrolyte 114 includes a ceramic fibrous matrix, such as LiAlO₂, and the first cathode 112 is formed by lithiating NiO in situ to yield the surface cathode catalyst. Alternatively, the first cathode 112 may be a metal doped lithium-metal oxide. The lithium-metal oxide may be LiFeO₂, Li₂MnO₃, LiCoO₂, or Li₂TiO₃, and the metal dopant may be Co, Nb, or a combination thereof. The porosity of the first cathode 112 may be from about 70% to about 80% by volume, or from about 75% to about 80% by volume. The average pore size within the first cathode 112 material may be from about 7 μm to about 15 μm, or about 9 μm to about 12 μm.

The first anode 116 may include a reduction catalyst (not shown) that catalyzes the reaction of carbonate and H₂ into CO₂ and water. The first anode 116 may be the reduction catalyst. In some embodiments, the first anode 116 may include the reduction catalyst over the anode support. The anode support or reduction catalyst of the first anode 116 may exhibit a porosity of about 45% by volume to about 70% by volume with an average pore size from about 3 μm to about 6 μm. The anode support or reduction catalyst may be formed of and include a metal, an alloy of at least two metals, a nickel-based cermet, lanthanide-doped ceria, or a combination thereof. The metal may be Ni, Cr, Al, Fe, Co, Pt, Pd, Ir, Ru, or a combination thereof. In some embodiments, the anode support or reduction catalyst of the first anode 116 includes a Ni—Cr alloy, where Ni—Cr is the reduction catalyst and comprises Cr at from about 2% by atomic composition to about 10% by atomic composition or about 4% by atomic composition to about 8% by atomic composition. In other embodiments, the alloy of at least two metals may comprise a Ni—Cr alloy, a Ni—Al alloy, or other Ni-based alloy. In some embodiments, a mixture of a Ni—Cr and Ni—Al alloy may be used, where Cr and Al comprise in total from about 10% to about 15% by weight of the total weight of the first anode 116. The nickel-based cermet may be nickel doped ceria (CeO₂). In some embodiments, the anode support or reduction catalyst of the first anode 116 may be the same material as the interconnect material 115, such as a Ni—Cr alloy.

The first electrolyte 114 comprises an electrolyte support matrix and an electrolyte salt. The electrolyte support matrix may be a ceramic fibrous matrix, such as lithium aluminum oxide (i.e., LiAlO₂). The electrolyte salt may be a metal carbonate, where the metal may be a Group I or Group II metal from the Periodic Table of Elements. The metal carbonate may be Li₂CO₃, K₂CO₃, Na₂CO₃, or a combination thereof. The electrolyte salt may be a mixture of metal carbonates, such as a eutectic mixture. The eutectic mixture may be a binary mixture, such as a mixture of 2:1 Li₂CO₃:K₂CO₃ or 1:1 K₂CO₃:Na₂CO₃. In some embodiments, the first electrolyte 114 is a LiAlO₂ matrix with K₂CO₃ as the electrolyte salt when the first cathode 112 includes lithiated NiO. In some embodiments, the first electrolyte 114 is a LiAlO₂ matrix with Li₂CO₃ as the electrolyte salt when the first cathode 112 includes NiO.

The relative dimensions (i.e., thicknesses, widths, heights) of one or more of the first cathode 112, the first anode 116, and the first electrolyte 114 may be substantially the same as one another or may be different from one another. In some embodiments, the thicknesses of the first cathode 112 and the first anode 116 are the same, and the thickness of each of the first cathode 112 and the first anode 116 are less than the thickness of the first electrolyte 114. In other embodiments, the thickness of the first cathode 112 is less than the thickness of the first anode 116, and the thickness of the first anode 116 is less than the thickness of the first electrolyte 114. In yet other embodiments, the thickness of the first cathode 112 is greater than the thickness of the first anode 116, and the thickness of the first electrolyte 114 is greater than the thickness of the first cathode 112. In some embodiments, the thicknesses of the first cathode 112 and the first electrolyte 114 are about the same. The first cathode 112 may have a thickness of from about 0.5 mm to about 1.0 mm, from about 0.6 mm to about 1.0 mm, from about 0.7 mm to about 1.0 mm, from about 0.8 mm to about 1.0 mm, from about 0.5 mm to about 0.9 mm, from about 0.5 mm to about 0.8 mm, or from about 0.5 mm to about 0.7 mm. The first anode 116 may have a thickness of from about 0.1 mm to about 1.0 mm, from about 0.2 mm to about 1.0 mm, from about 0.4 mm to about 1.0 mm, from about 0.6 mm to about 1.0 mm, from about 0.1 mm to about 0.8 mm, or from about 0.1 mm to about 0.6 mm. The first electrolyte 114 may have a thickness of from about 0.5 mm to about 1.0 mm, from about 0.6 mm to about 1.0 mm, from about 0.7 mm to about 1.0 mm, from about 0.8 mm to about 1.0 mm, from about 0.5 mm to about 0.9 mm, from about 0.5 mm to about 0.8 mm, or from about 0.5 mm to about 0.7 mm.

The second electrochemical cell 120 may be a proton conducting electrolyzer (PCE), where the PCE includes the second cathode 122, the second anode 126, and the second electrolyte 124 interposed between the second cathode 122 and the second anode 126. The second anode 126 of the second electrochemical cell 120 is configured to oxidize the second feed stream 128 comprising a hydrogen-containing gas, such as water, and reduce (e.g., chemically reduce) hydrogen ions into hydrogen gas.

$${H}_{2} O \to \frac{1}{2} {O}_{2} + 2 {e}^{-} + 2 {H}^{+} \qquad ( 3 )$$

The second anode 126 comprises a water oxidation catalyst that oxidizes the second feed stream 128, which is delivered to the second electrochemical cell 120 via a second inlet 138. The produced electrons and hydrogen ions diffuse through the second electrolyte 124 to the second cathode 122, while the produced dioxygen diffuses away from the second electrochemical cell 120 in a second output stream 129. The second cathode 122 comprises a hydrogen reduction catalyst that is formulated to reduce the hydrogen ions into hydrogen gas:

2e⁻+2H⁺→H₂ (4)

Hydrogen gas diffuses through the interconnect material 115 to the first anode 116, where the hydrogen gas undergoes oxidation, as described in eq. 2.

The relative dimensions and configurations of the second anode 126, the second cathode 122, and the second electrolyte 124 are as described above for the first cathode 112, the first anode 116, and the first electrolyte 114 in the first electrochemical cell 110.

The second anode 126 comprises a support material and the water oxidation catalyst. In some embodiments, the entire second anode 126 comprises the water oxidation catalyst. In some embodiments, the water oxidation catalyst is on the surface of the second anode 126, and the water oxidation catalyst is formulated to catalyze the reaction of starting materials (e.g., water) in the second feed stream 128. The water oxidation catalyst converts the starting materials within the second feed stream 128 into a second output stream 129, where the second output stream 129 comprises dioxygen gas. The second output stream 129 is delivered away from the system 100 via a second outlet 139. The second anode 126 may be formed of and include at least one catalyst-doped material compatible with the material compositions of the second electrolyte 124, the second feed stream 128, the second cathode 122, and the operating conditions (e.g., temperature, pressure, current density, etc.) of the second electrochemical cell 120.

The water oxidation catalyst may comprise a single material (e.g., a single metal) or at least two materials. For example, the water oxidation catalyst may be a supported metal catalyst doped with a metal. The metal may be palladium (Pd), platinum (Pt), rhodium (Rh), ruthenium (Ru), iridium (Ir), nickel (Ni), cobalt (Co), or a combination thereof. The supported metal catalyst may be a perovskite material, such as BZCYYb, BSNYYb, doped BaCeO₃, BaZrO₃, Ba₂(YSn)O_{5.5}, Ba₃(CaNb₂)O₉. The perovskite material of the water oxidation catalyst may be doped with Fe, Ni, Zr, Au, Pd, Pt, Ir, Rh, Ru, Co, or a combination thereof. The water oxidation catalyst may be BZCYYb doped with Ni (e.g., Ni—BZCYYb, Ni-BSNYYb, Ni—BaCeO₃, Ni—BaZrO₃, Ni—Ba₂(YSn)O_{5.5}, Ni—Ba₃(CaNb₂)O₉) or BZCYYb doped with a Co—Fe alloy. In some embodiments, the second anode 126 includes an anode support of BaCe_{0.4}Zr_{0.4}Y_{0.1}Yb_{0.1}O₃ doped with BaCo_{0.4}Fe_{0.4}Zr_{0.1}Y_{0.1}O₃ as the water oxidation catalyst.

The second cathode 122 may comprise a single material (e.g., a single metal) or at least two materials (e.g., a bimetallic material). Similar to the second anode 126, the second cathode 122 may be formed of and include at least one catalyst-doped material compatible with the material compositions of the second electrolyte 124, the second product stream 135, the second anode 126, and the operating conditions of the second electrochemical cell 120. The second cathode 122 may be an alloy, such as an AgPd alloy or a Ni-based alloy. The second cathode 122 may, for example, comprise a cermet material comprising at least one catalyst material including one or more of a metal, metal alloy, or at least one perovskite, such as a doped perovskite cermet material, denoted as M-perovskite, where M may be a metal, such as a noble metal (e.g., Pt, Pd, Rh, Ru, Ir), Fe, Ag, or a combination thereof, a metal oxide or another material. For example, and not by limitation, the second cathode 122 may comprise M-BZCYYb, M-BSNYYb, M-PrBa_{0.5}Sr_{0.5}Co_{1.5}Fe_{0.5}O_{5+δ} (M-PBSCF), M-PrNi_{0.5}Co_{0.5}O_{3-δ} (M-PNC), M-Pr_{0.5}Ba_{0.5}CoₓFe₁₋ₓO₃, M-BaCe_{0.9}Y_{0.1}O₃, M-BaCe_{0.4}Zr_{0.4}Y_{0.1}Yb_{0.1}O₃, M-Pr_{0.5}Ba_{0.5}FeO₃, M-BaCeO₃, M-BaZrO₃, M-Ba₂(YSn)O_{5.5}, M-Ba₃(CaNb₂)O₉), an MNi/perovskite (such as RuNi/perovskite) cermet (MNi-perovskite, such as RuNi-perovskite) material (e.g., MNi-BZCYYb, MNi-BSNYYb, MNi-PBSCF, MNi-PNC, MNi-Pr_{0.5}Ba_{0.5}CoₓFe₁₋ₓO₃, MNi-Pr_{0.5}Ba_{0.5}FeO₃, MNi-BaCeO₃, MNi-BaZrO₃, MNi-Ba₂(YSn)O_{5.5}, MNi-Ba₃(CaNb₂)O₉), an MCe/perovskite cermet (such as a RuCe-perovskite) material (e.g., MCe-BZCYYb, MCe-BSNYYb, MCe-PBSCF, MCe-PNC, MCe-Pr_{0.5}Ba_{0.5}CoₓFe₁₋ₓO₃, MCe-Pr_{0.5}Ba_{0.5}FeO₃, MCe-BaCeO₃, MCe-BaZrO₃, MCe-Ba₂(YSn)O_{5.5}, MCe-Ba₃(CaNb₂)O₉), and an MNiCe/perovskite cermet (RuNiCe-perovskite) material (e.g., RuNiCe-BZCYYb, RuNiCe-BSNYYb, RuNiCe-PBSCF, RuNiCe-PNC, RuNiCe—Pr_{0.5}Ba_{0.5}CoₓFe₁₋ₓO₃, RuNiCe—Pr_{0.5}Ba_{0.5}FeO₃, RuNiCe—BaCeO₃, RuNiCe—BaZrO₃, RuNiCe—Ba₂(YSn)O_{5.5}, RuNiCe—Ba₃(CaNb₂)O₉. The second cathode 122 may be, for example, a metal-doped ceria, such as lanthanum-doped ceria (LDC), samarium-doped ceria (SDC), or a combination thereof. In some embodiments, the second cathode 122 is BaCe_{0.4}Zr_{0.4}Y_{0.1}Yb_{0.1}O₃ doped with NiO as the hydrogen reduction catalyst.

The second electrolyte 124 comprises at least one electrolyte material exhibiting ionic conductivity, such as H⁺ conductivity. In some embodiments, the second electrolyte 124 is a proton exchange membrane (PEM). The second electrolyte 124 enables H⁺ to move from the second anode 126 to the second cathode 122. The second electrolyte 124 may exhibit a thickness to effectively transfer H⁺ but not so thick as to require a large over potential to sustain H⁺ transport. For instance, if the thickness of the second anode 126 and the second cathode 122 is substantially the same, the thickness of the second electrolyte 124 is at least the sum of the thicknesses of the second anode 126 and the second cathode 122. In some embodiments, the thickness of the second electrolyte 124 is substantially the same as one of the second anode 126 or the second cathode 122. In some embodiments, the second anode 126 is of sufficient thickness to provide mechanical support for the system 100, and the thickness of the second electrolyte 124 may be from about 5 μm to about 10 μm, from about 6 μm to about 10 μm, from about 7 μm to about 10 μm, from about 8 μm to about 10 μm, from about 5 μm to about 9 μm, or from about 5 μm to about 8 μm.

The second electrolyte 124 may be formed of a material that exhibits an ionic conductivity of greater than or equal to about 10'S/cm (e.g., within a range of from about 10'S/cm to about 1 S/cm) at one or more temperatures within a range of from about 150° C. to about 700° C. (e.g., from about 300° C. to about 650° C., or from about 400° C. to about 500° C.). In addition, the second electrolyte 124 may be formulated to remain substantially adhered (e.g., laminated) to the second cathode 122 and the second anode 126 at relatively high current densities, such as at current densities greater than or equal to about 0.1 amperes per square centimeter (A/cm²) (e.g., greater than or equal to about 0.5 A/cm², greater than or equal to about 1.0 A/cm², greater than or equal to about 2.0 A/cm², etc.). For example, the second electrolyte 124 may comprise one or more of a solid acid material, a polybenzimidazole (PBI) material (e.g., a doped PBI material), and a BZCYYb material (e.g., BaZr_{0.1}Ce_{0.7}Y_{0.1}Yb_{0.1}O_{3-δ} or a doped variant). The material composition of the second electrolyte 124 may provide the second electrolyte 124 with enhanced ionic conductivity at a temperature within the range of from about 150° C. to about 700° C. (e.g., from about 300° C. to about 650° C., or from about 400° C. to about 500° C.).

The second electrolyte 124 comprises a perovskite material (e.g., a BZCYYb, a BSNYYb, a doped BaCeO₃, a doped BaZrO₃, Ba₂(YSn)O_{5.5}, Ba₃(CaNb₂)O₉, etc.) having an operational temperature within a range of from about 350° C. to about 650° C. (e.g., from about 350° C. to about 500° C., or about 400° C. to about 600° C.), the second cathode 122 may comprise a catalyst-doped perovskite material compatible with the perovskite material of the second electrolyte 124. In some embodiments, the second electrochemical cell 120 comprises BaZr_{0.1}Ce_{0.7}Y_{0.1}Yb_{0.1}O₃ as the second electrolyte 124, NiO-doped BaZr_{0.1}Ce_{0.7}Y_{0.1}Yb_{0.1}O₃ as the second cathode 122, and BaCo_{0.4}Fe_{0.4}Zr_{0.1}Y_{0.1}O₃-doped BaZr_{0.1}Ce_{0.7}Y_{0.1}Yb_{0.1}O₃ as the second anode 126.

In some embodiments, the second electrolyte 124 is formed of and includes at least one perovskite material having an operational temperature (e.g., a temperature at which the H⁺ conductivity of the perovskite material is greater than or equal to about 10⁻² S/cm, such as within a range of from about 10⁻² S/cm to about 10⁻¹ S/cm), within a range of from about 350° C. to about 700° C. (e.g., from about 350° C. to about 500° C., or from about 400° C. to about 600° C.). In some embodiments, the perovskite material is a proton conducting ceramic. As a non-limiting example, the second electrolyte 124 may comprise one or more of a yttrium- and ytterbium-doped barium-zirconate-cerate (BZCYYb), a yttrium- and ytterbium-doped barium-strontium-niobate (BSNYYb), doped barium-cerate (BaCeO₃) (e.g., yttrium-doped BaCeO₃ (BCY)), doped barium-zirconate (BaZrO₃) (e.g., yttrium-doped BaCeO₃ (BZY)), barium-yttrium-stannate (Ba₂(YSn)O₅₅); and barium-calcium-niobate (Ba₃(CaNb₂)O₉). In some embodiments, the second electrolyte 124 comprises BZCYYb (e.g., BaZr_{0.1}Ce_{0.7}Y_{0.1}Yb_{0.1}O_{3-δ} and BaZr_{0.4}Ce_{0.4}Y_{0.1}Yb_{0.1}O_{3-δ}).

The interconnect material 115 is formulated and configured to separate the produced CO₂ and water into two separate streams. The interconnect material 115 may be a gas diffusion layer (GDL) that facilitates transport (e.g., diffusion) of produced gases between the first anode 116 of the first electrochemical cell 110 and the second cathode 122 of the second electrochemical cell 120. Additionally, generated electrons at the first anode 116 diffuse to the second cathode 122, where the second cathode 122 catalyzes hydrogen ion reduction to produce hydrogen gas. In other words, electrons and hydrogen gas may travel along antiparallel trajectories relative to each other through the interconnect material 115.

The interconnect material 115 may be formed of and include a porous material to allow for gas transport. The interconnect material 115 may be made of and include a material that exhibits thermal conductivity and electrical conductivity. The interconnect material 115 may be a metal material or a polymeric material and include a porosity of from about 20% by volume to about 50% by volume (e.g., from about 30% by volume to about 40% by volume). The polymeric material of the interconnect material 115 may be a carbon-based material, such as carbon cloth, carbon paper, graphite, carbon black, and the like. In some embodiments, the polymeric material of the interconnect material 115 may be doped with polytetrafluoroethylene (PTFE). The interconnect material 115 may be an ordered material, such as a regular metal foam. The interconnect material 115 may be a disordered material, such as a stochastic foam. The pores within the interconnect material 115 may be homogeneously distributed. In some embodiments, the pores within the interconnect material 115 may be randomly distributed. In some embodiments, the interconnect material 115 comprises phases of varying porosity. The interconnect material 115 may also exhibit conductive properties. The interconnect material 115 may also resist degradation in the presence of water. The interconnect material 115 may comprise a single material (e.g., a metal) or at least two materials (e.g., a bimetallic material). The interconnect material 115 may be a metal, such as Al, Fe, Ni, Cr, Au, Pd, Pt, Ir, Rh, Ru, Co, or a combination thereof. The interconnect material 115 may be a metallic foam, such as a bimetallic foam. In some embodiments, the interconnect material is an iron and chromium allow (e.g., stainless steel). In other embodiments, the interconnect material 115 is a NiCr alloy. In further embodiments, the interconnect material 115 is a NiCr foam.

Concentrated CO₂ is recovered from the system 100 as the first product stream 130. A CO₂-depleted stream (i.e., first output stream 119) may also be recovered. The first product stream 130 containing concentrated CO₂ exiting from the system 100 may have an increased concentration of CO₂ relative to the concentration of CO₂ in the first feed stream 118. In this respect, the first product stream 130 may contain at least about 2-fold, at least about 4-fold, at least about 6-fold, at least about 8-fold, at least about 10-fold, at least about 12-fold, at least about 14-fold, at least about 16-fold or at least about 20-fold more CO₂ compared to the amount of CO₂ in the first feed stream 118, based upon the same volume of air in the first feed stream 118 and the first product stream 130. The first product stream 130 may also be of a high purity. By way of example only, the CO₂ of the first product stream 130 may have a purity of greater than about 90% by volume, such as greater than about 95% by volume or greater than about 99% by volume. The CO₂ of the first product stream 130 may be collected for use as a starting material or as a commodity chemical. The CO₂ of the first product stream 130 may, for example, be used in various industries, such as in oil recovery, chemical production/manufacturing, or coal-fired power plants. Since the CO₂ of the first product stream 130 may be produced at a low cost, the recovered CO₂ may be used in various industrial processes that are currently too expensive to conduct using the CO₂ recovered from conventional DAC processes. For example, the concentrated CO₂ may be used to enhance oil recovery by CO₂ injection, production of carbon-neutral synthetic fuel and plastics, food/beverage carbonation, or agriculture, such as enhancing productivity of algae farms. The CO₂, if present, in the first output stream 119 may also be collected for use as a starting material or as a commodity chemical.

The system 100 may further include heating apparatuses that maintain substantially the same temperature across the system 100. The system 100 may operate at midrange temperatures. By nonlimiting example, the system 100 may be heated to and operate at a temperature of from about 500° C. to about 700° C., such as from about 500° C. to about 550° C., from about 500° C. to about 600° C., from about 500° C. to about 650° C., from about 550° C. to about 700° C., from about 600° C. to about 700° C., from about 650° C. to about 700° C., from about 550° C. to about 650° C., or from about 600° C. to about 650° C. Additionally, the system 100 may operate at an internal pressure of about 1 bar with minimal pressure drop across the system 100, across the first electrochemical cell 110, and across the second electrochemical cell 120. In some embodiments, the system 100 operates at a temperature of about 650° C.

While not shown, the system 100 may include one or more apparatuses (e.g., heat exchangers, blowers, pumps, valves, compressors, expanders, mass flow control devices, DC power sources, condensers, steam generators, etc.) to adjust one or more of temperature, pressure, and flow rate of the first feed stream 118 and the second feed stream 128 delivered to the first headspace 132 and second headspace 134, respectively. The flow rates for the first feed stream 118 and second feed stream 128 may be adjusted depending on the compositions of the first feed stream 118 and second feed stream 128. The flow rates may range from about 20 ml min⁻¹ to about 150 ml min⁻¹, e.g., about 20 ml min⁻¹ to about 100 ml min⁻¹, about 50 ml min⁻¹ to about 100 ml min⁻¹, about 70 ml min⁻¹ to about 150 ml min⁻¹, or about 50 ml min⁻¹ to about 150 ml min⁻¹. The internal operating pressure of the system 100 may be about 1 bar.

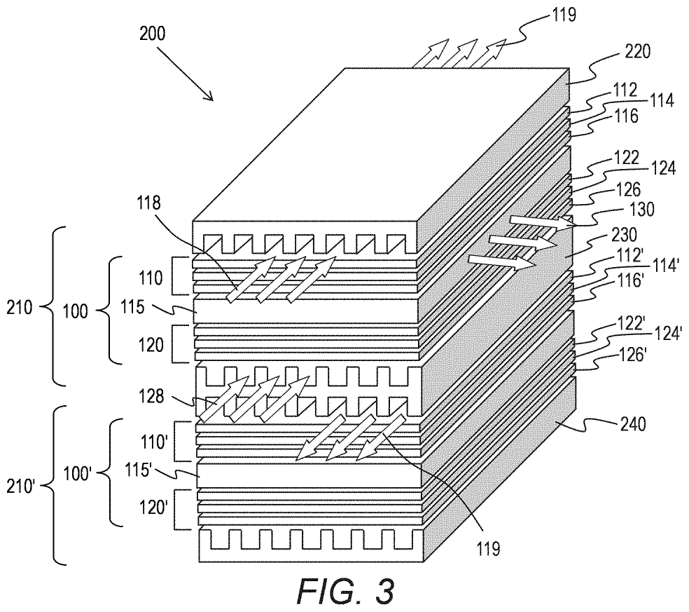

The system 100 as described above may be integrated into a multicomponent device 200 that includes multiple systems (100, 100′, 100″, etc.), as illustrated in FIG. 3. Each of the systems 100 or 100′ may be stacked as modules 210 to maximize CO₂ capture from ambient air, where each of the modules 210 includes the system 100 as described above.

The module 210 may further include an endplate 220, which may include an inert material that allows the first feed stream 118 or the second feed stream 128 (see FIG. 2) to interact with the components of the system 100. Each of the modules 210 may further include another endplate 240 that is part of a spacer 230. The spacer 230 is interposed between the modules 210 and the adjacent module 210′. The spacer 230, endplate 220, and endplate 240 allow for the inward and outward flux of feed streams, output streams, and product streams while also spatially separating each of the systems 100 and 100′.

Each of the systems 100, 100′ in the modules 210 are configured to receive the first feed stream 118. In some embodiments, each of the systems 100, 100′ are configured to receive each of the first feed streams 118, which flow in the same direction. Each of the systems 100, 100′ of the modules 210 may be configured to generate the first product stream 130 in the same direction as the adjacent systems 100′. In some embodiments, a plurality of first feed streams 118 pass through each of the systems 100, 100′, interact with each of the first cathodes 112, and produce a plurality of first output streams 119 that exit the multicomponent device 200. Each first output stream 119 may be substantially free of CO₂. In some embodiments, the first feed stream 118 and the first output stream 119 are antiparallel to each other. In some embodiments, the first feed stream 118 and the first product stream 130 are oriented perpendicular to each other.

Each of the systems 100, 100′ in the modules 210 are configured to receive a plurality of second feed streams 128 comprising water. Each of the second feed streams 128 interact with each of the second anodes 126 of the systems 100, 100′ to produce a second output stream 129 comprising dioxygen. Each of the second feed streams 128 is oxidized to form hydrogen ions in each of the second electrochemical cells 120, and the produced hydrogen ions diffuse to the first electrochemical cell 110 to produce the second product stream 135 comprising water. The plurality of second product streams 135 may be used as the second feed stream 128 into the system 100, 100′. In some embodiments, the plurality of second product streams 135 may be used as the second feed stream 128 into an adjacent system 100′.

The systems 100, 100′ disclosed herein may be scalable, modular, highly efficient, hybrid electrochemical systems for continuous carbon capture. The systems may include two electrochemical cells, i.e., the MCFC and the PCE, where the MCFC may continuously capture CO₂ from the air, and the PCE produces renewable H₂ to drive the CO₂ capture. The PCE continuously degrades and produces water as a source of hydrogen gas for CO₂ capture. Specifically, the systems 100, 100′ are capable of directly and continuously capturing CO₂ from a source stream such as ambient air and using the hydrogen gas produced in the PCE. Using the input water stream from the PCE, the MCFC may also produce water as steam that may be recycled for hydrogen gas production in the PCE. The systems 100, 100′ may be a closed-loop system for continuously using water as a source of hydrogen gas, thus enabling net-zero water consumption.

The systems 100, 100′ disclosed herein circumvent the high regeneration energies associated with conventional amine-based absorbents to free CO₂ because the PCE uses the energy generated at the exothermic MCFC in lieu of additional energetic input to recapture CO₂. In a symbiotic manner, the exothermic CO₂ oxidation reaction provides thermal energy that assists in catalytic oxidation of water to dioxygen, thus lowering the energetic input at the PCE. Additionally, by coupling the endothermic PCE and the exothermic MCFC, the systems 100, 100′ are capable of maintaining a spatially uniform distribution of heat, minimizing energetic losses due to heat and, thus, reducing the cost of operation. Furthermore, the systems 100, 100′ operate at intermediate temperatures, such as from about 500° C. to about 700° C., from about 500° C. to about 550° C., from about 500° C. to about 600° C., from about 500° C. to about 650° C., from about 550° C. to about 700° C., from about 600° C. to about 700° C., from about 650° C. to about 700° C., from about 550° C. to about 650° C., or from about 600° C. to about 650° C.

The systems 100, 100′ further reduce the cost of operation by using the energy generated by the reactions at the MCFC and PCE to power itself. The MCFC and PCE each generate energy from each of the anode reactions of the MCFC and PCE, and the systems 100, 100′ is configured to recycle produced energy back into the system, thereby lowering the auxiliary power input.

Dimensions and configurations of the systems 100, 100′ may be relatively small, resulting in the modules 210 being compact and easily transported to desired locations of use.

The system and associated device disclosed herein directly and continuously capture CO₂ from a source stream, such as ambient air, and may be transportable and use a reduced energy input. The system and device may be used in multiple fields, such as in enhanced oil recovery by CO₂ injection, chemical manufacturing by production of carbon-neutral synthetic fuel and plastics, food and beverage carbonation, agriculture (e.g., enhancing productivity of algae farms, etc.), among others. The system and device may also be used at concentrated point sources, such as coal-fired power plants. Furthermore, the system and device disclosed herein may directly and continuously capture and concentrate CO₂ from diluted source streams while simultaneously generating electricity. In contrast to conventional systems, the system and device according to embodiments of the disclosure consumes H₂ as part of CO₂ capture, rather than natural gas, to power direct air capture, thus enabling net-zero carbon emissions or negative emissions.

In light of the ability of the system and device to continuously capture CO₂ and provide a concentrated source thereof, the disclosure also provides a method for capturing and concentrating CO₂. In accordance with this method, a first feed stream including CO₂ and dioxygen is provided to a first cathode of a first electrochemical cell where the CO₂ is reduced to produce carbonate ions. The carbonate ions subsequently diffuse to a first anode of the first electrochemical cell and are reduced to produce a first product stream composed of concentrated CO₂ and a second product stream composed of water. A second feed stream including water, which in some embodiments is recycled from the second product stream, is subsequently provided to a second anode of a second electrochemical cell and oxidized to produce hydrogen ions and dioxygen gas. The hydrogen ions then diffuse to a second cathode of the second electrochemical cell where they are reduced to hydrogen gas. Advantageously, the hydrogen gas produced by the second cathode diffuses to the first anode, providing a closed-loop, continuous system.

### EXAMPLES

### Example 1

The MCFC was fabricated as an electrolyte (LiAlO₂-carbonate) supported cell with lithiated nickel oxide and Ni—Cr alloy as cathode and anode, respectively. In order to synthesize LiAlO₂/K₂CO₃ composite electrolytes, the carbonate powders were prepared by mixing Li₂CO₃ and K₂CO₃ in a mole ratio of 2:1 and then calcinated at 600° C. for 2 h. The carbonate mixture was mixed with Al₂O₃ with a weight ratio of 7:3 (LiAlO₂/K₂CO₃). The mixed LiAlO₂-carbonates composite powder was then thoroughly ground and heated at 700° C. in air for 4 h. The resultant mixture after heat treatment was then ground and tape casted into a thick electrolyte tape. Coupons with targeted shape and size were cut from the tape, followed by annealing at 750° C. in air for 4 h to form the densified electrolyte support. With regard to the MCFC electrodes, lithiated nickel oxide were adopted as cathode. Ni—Cr alloy was used as anode. Both the cathode and anode were screen printed on the composite electrolyte pellet, followed by annealing to form the final MCFC.

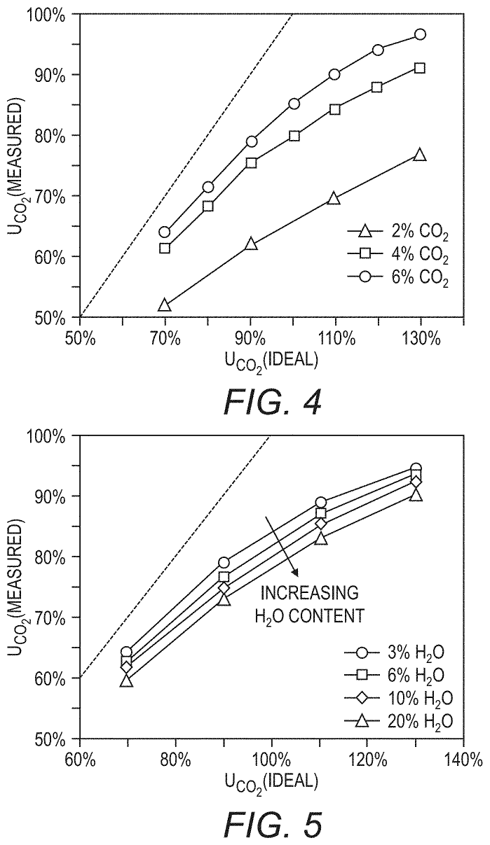

The performance of the MCFC as a function of target CO₂ capture was assessed at different cathode CO₂ concentrations (FIG. 4) and varying water contents (FIG. 5). This analysis indicated that increasing the current density of the MCFCs, which is proportional to the ideal CO₂ capture efficiency (i.e., Faradaic law), lead to higher power output and increased the CO₂ capture efficiency to >95% (FIG. 4). CO₂ capture efficiency of >99% was demonstrated in lab-scale reactors. It should be noted that the measured CO₂ capture efficiency was lower than the ideal CO₂ capture efficiency, which was ascribed to the fact that H₂O can react with O₂ to produce hydroxide ions at the cathode. Thus, air humidity could impact the CO₂ capture efficiency. As shown in FIG. 5, low steam (H₂O) concentration tended to enhance the CO₂ capture efficiency, suggesting that the DAC system may be prone to capture CO₂ from dry air. Thus, in some embodiments, the system further may include a mechanism to control the steam concentration in the air stream, improving the CO₂ capture efficiency.

### Example 2

Proton-conducting ceramic electrolyzers (PCE) have been shown to efficiently generate H₂ (Duan et al. (2019) Nature Energy 4(3):230-240). The PCE membrane electrode assembly (MEA) was composed of a porous cathode, dense electrolyte, and anode. A multilayer coating system was used for fabricating the half cells (cathode and electrolyte). The half cells were then sintered at 1450° C. for 10 hours (Duan et al. (2018) Nature 557(7704):217-222; Duan et al. (2015) Science 349(6254):1321-1326). The porous anode layer was subsequently applied over the electrolyte via screen printing and sintered at a lower temperature (900° C.) to obtain a porous structure that favors the oxygen evolution reaction. The active electrode area of the PCE MEA was 64 cm² per cell.

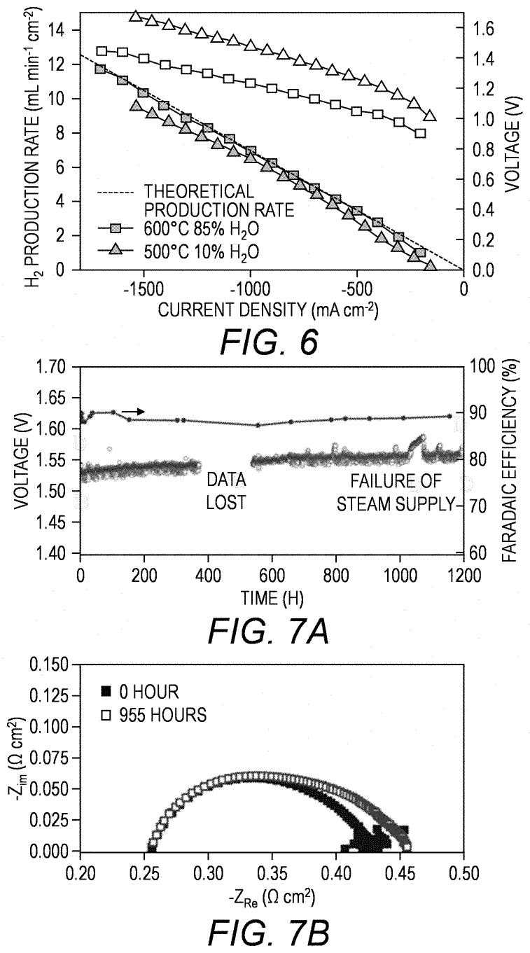

As shown in FIG. 6, the PCE achieved a high Faradaic efficiency (90-98%) and operated endothermically (when an appropriate waste heat source was available from MCFC) with >97% overall electric-to-H₂ energy conversion efficiency (LHV_{H}_{₂}) at a current density of 923 mA cm⁻². As shown in FIG. 6, at an applied external voltage of 1.4V and 600° C., a current density of >1700 mA cm⁻² and a Faradaic efficiency of >98% was delivered. The PCEs used in this analysis employed an all-perovskite BaCo_{0.4}Fe_{0.4}Zr_{0.1}Y_{0.1}O_{3-δ} (BCFZY) oxygen electrode (or steam electrode). The excellent performance and stability of the BCFZY positive electrode indicated that it is a highly effective catalyst for the oxygen evolution reaction.

### Example 3

Long-term stability and degradation analysis of the PCE in Example 2 was performed. PCEs were tested under electrolysis mode operation at a current density of 1385 mA cm⁻² for 1200 hours at 550° C. This analysis indicated negligible degradation in Faradaic efficiency and a low voltage degradation rate of <25 mV/1000 h (FIG. 7A). This result is comparable to the state-of-the-art solid oxide electrolyzer cells (SOECs). Electrochemical impedance spectroscopy (FIG. 7B) measurements showed that the electrolyte was stable for ˜1000 hours.

### Example 4

A system of the disclosure was prepared with an MCFC and a PCE connected by a porous Ni—Cr alloy interconnector. The system components included the materials listed in Table 1.

TABLE 1

| | Material | | |
|---|---|---|---|
| System Component | Cathode | Electrolyte | Anode |
| MCFC | In situ lithiated NiO | LiAlO₂ matrix filled with | Ni—Cr alloy |
| | | the K₂CO₃ | |
| PCE | 40% | BaCe_{0.4}Zr_{0.4}Y_{0.1}Yb_{0.1}O₃ | BaCe_{0.4}Zr_{0.4}Y_{0.1}Yb_{0.1}O₃ + |
| | BaCe_{0.4}Zr_{0.4}Y_{0.1}Yb_{0.1}O₃ + | | BaCe_{0.4}Fe_{0.4}Zr_{0.1}Y_{0.1}O₃ |
| | 60% NiO | | |

| | |
|---|---|
| Interconnector | Porous Ni—Cr alloy interconnector, Ni—Cr alloy foam |

The properties and performance parameters of these materials are provided in Table 2.

TABLE 2
Materials Properties

| | |
|---|---|
| Nominal Thickness of | MCFC: 300 to 500 |
| Selective Layer (μm) | PCE: 5 to 10 μm |
| Membrane Geometry | Planar |
| Hours tested without | >1200 to 5000 |
| significant degradation | |

Membrane Performance

| | |
|---|---|
| Temperature (° C.) | 650 (MCFC and PCE) |
| Pressure Normalized Flux | 0.01 to >0.02 cm³/(cm² · s) |
| for Permeate (CO₂) (GPU) | |
| CO₂/H₂O Selectivity | >95% |
| CO₂/N₂ Selectivity | 95-99% |
| Type of Measurement (Ideal | Mixed gas |
| or mixed gas) | |

A coupled single cell was fabricated by coupling one MCFC MEA and one PCE MEA via a porous Ni—Cr alloy interconnector. The coupled single cells were then stacked using interconnectors and sealants. Interconnectors and commercially viable sealants for MCFC stacks and SOEC stacks were used.

The interconnector functions as both a gas diffusion layer (GDL) and a current collector. Air was fed to the MCFC cathode, where CO₂ reacted with O₂ and electrons to form carbonate ions. Carbonate ions then migrated to the MCFC anode across the electrolyte matrix and reacted with H₂ to produce and concentrate CO₂. H₂ was produced from the PCE's membrane electrode assembly, which included the dense proton-conducting electrolyte membrane, porous anode, and porous cathode. H₂ produced at the PCE cathode directly diffused into the anode of MCFC through the porous Ni—Cr alloy interconnector. The porous Ni—Cr alloy interconnector also conducted electrons. Electrons produced at the MCFC anode were, therefore, directly used for the H₂ evolution reaction. Additionally, Ni—Cr alloy displayed an exceptionally high thermal conductivity, and heat from the MCFCs was used for the PCEs. Thus, the interconnector simultaneously enabled electron conduction, gas diffusion, and heat transfer, simplifying the hybrid reactor's thermal and power management.

### Example 5

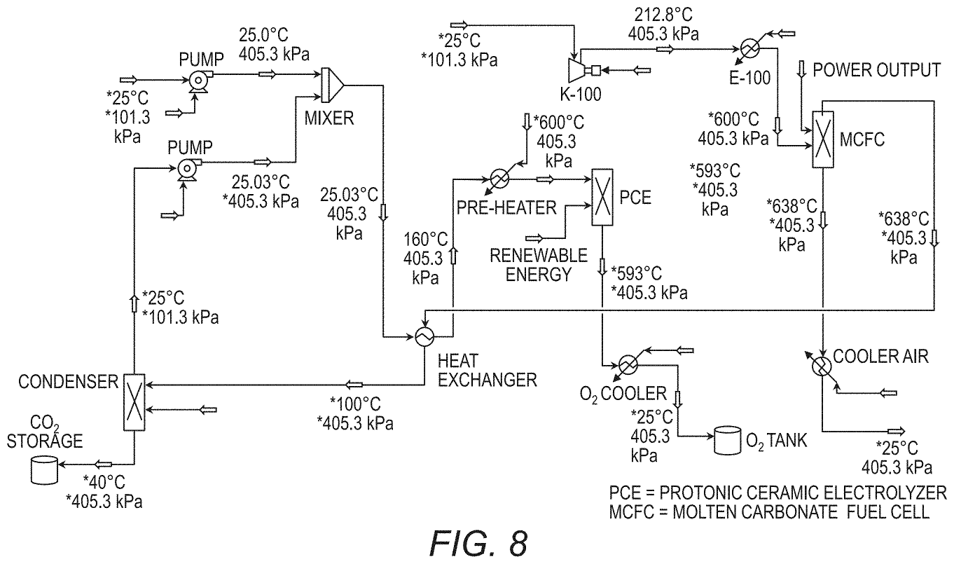

As shown in FIG. 8, an Aspen-HYSYS model was developed to demonstrate the use of the system of the disclosure with other components. The model indicated that water, heat, and power generated by the MCFC provided optimum integration of the system. Such a heat source was used to preheat the inlet water stream to the PCE. The power generated by the MCFC was also partially used to feed the PCE. Water generated by the MCFC was separated and heated to be used again in the system, reducing the amount of freshwater needed.

Although the foregoing descriptions contain many specifics, these are not to be construed as limiting the scope of the disclosure, but merely as providing certain exemplary embodiments. Similarly, other embodiments of the disclosure may be devised that do not depart from the scope of the disclosure. For example, features described herein with reference to one embodiment may also be provided in others of the embodiments described herein. The scope of the embodiments of the disclosure is, therefore, indicated and limited only by the appended claims and their legal equivalents, rather than by the foregoing description. All additions, deletions, and modifications to the disclosure, as disclosed herein, which fall within the meaning and scope of the claims, are encompassed by the disclosure.

What is claimed is:

1. A method for capturing carbon dioxide, the method comprising:
introducing a first feed stream comprising carbon dioxide and dioxygen into a first electrochemical cell;
reducing the carbon dioxide to carbonate ions at a first cathode of the first electrochemical cell;
reducing the carbonate ions at a first anode of the first electrochemical cell to produce a first product stream comprising concentrated carbon dioxide and a second product stream comprising water;
introducing a second feed stream comprising water to a second electrochemical cell coupled to the first electrochemical cell;
oxidizing the water of the second feed stream at a second anode of the second electrochemical cell to produce hydrogen ions and dioxygen gas;
reducing the hydrogen ions to hydrogen gas at a second cathode of the second electrochemical cell;
transporting the hydrogen gas produced by the second cathode of the second electrochemical cell to the first anode of the first electrochemical cell; and
removing the first product stream from the first electrochemical cell.

2. The method of claim 1, wherein introducing a first feed stream comprising carbon dioxide and dioxygen into a first electrochemical cell comprises introducing the first feed stream comprising carbon dioxide and dioxygen into a molten carbonate fuel cell.

3. The method of claim 1, wherein introducing a first feed stream comprising carbon dioxide and dioxygen into a first electrochemical cell comprises introducing air into the first electrochemical cell.

4. The method of claim 1, wherein introducing a first feed stream comprising carbon dioxide and dioxygen into a first electrochemical cell comprises introducing a first feed stream comprising less than about 1200 parts per million (ppm) of carbon dioxide into the first electrochemical cell.

5. The method of claim 1, wherein introducing a first feed stream comprising carbon dioxide and dioxygen comprises introducing a carbon dioxide-containing feed stream from a coal fired power plant or from an ethanol fermenter.

6. The method of claim 1, wherein reducing the carbonate ions to produce a first product stream comprising concentrated carbon dioxide comprises producing the first product stream comprising a greater concentration of carbon dioxide than the concentration of carbon dioxide in the first feed stream.

7. The method of claim 1, wherein introducing the second feed stream comprising water to a second electrochemical cell comprises introducing the second feed stream comprising water to a proton conducting electrolyzer.

8. The method of claim 1, wherein reducing the carbon dioxide to carbonate ions in the first electrochemical cell and reducing the carbonate ions to produce a first product stream comprising concentrated carbon dioxide comprises producing thermal energy.

9. The method of claim 8, further comprising using the thermal energy from the first electrochemical cell to oxidize the water of the second feed stream in the second electrochemical cell.

10. The method of claim 1, further comprising maintaining the first electrochemical cell and the second electrochemical cell at a temperature of from about 500° C. to about 700° C.

11. The method of claim 1, wherein reducing the hydrogen ions to hydrogen gas at a second cathode of the second electrochemical cell comprises using electrons generated by the first anode of the first electrochemical cell to reduce the hydrogen ions in the second electrochemical cell.

12. A method for capturing carbon dioxide, the method comprising:
introducing a first feed stream comprising air into a molten carbonate fuel cell maintained at a temperature of from about 500° C. to about 700° C.;
reducing carbon dioxide from the air to carbonate ions at a cathode of the molten carbonate fuel cell;
transporting the carbonate ions through an electrolyte of the molten carbonate fuel cell;
reducing the carbonate ions at an anode of the molten carbonate fuel cell to produce a first product stream comprising carbon dioxide and a second product stream comprising water;
introducing the second product stream comprising water to a proton conducting electrolyzer coupled to the molten carbonate fuel cell and maintained at a temperature of from about 500° C. to about 700° C.;
oxidizing the water of the second product stream at an anode of the proton conducting electrolyzer to produce hydrogen ions and dioxygen gas;
transporting the hydrogen ions through an electrolyte of the proton conducting electrolyzer;
reducing the hydrogen ions to hydrogen gas at a cathode of the proton conducting electrolyzer; and
transporting the hydrogen gas to the anode of the molten carbonate fuel cell; and recovering the first product stream from the molten carbonate fuel cell.

13. The method of claim 12, wherein transporting the hydrogen gas to the anode of the molten carbonate fuel cell comprises transporting the hydrogen gas through an interconnect material comprising a gas diffusion layer, the interconnect material between the molten carbonate fuel cell and the proton conducting electrolyzer.

14. The method of claim 13, further comprising transferring thermal energy produced at the molten carbonate fuel cell to the proton conducting electrolyzer through the interconnect material.

15. A system for capturing carbon dioxide, the system comprising:
at least one first electrochemical cell comprising:
a first cathode formulated to oxidize a first feed stream comprising carbon dioxide and dioxygen to carbonate ions; and
a first anode formulated to reduce the carbonate ions to carbon dioxide and water; and
at least one second electrochemical cell coupled to the first electrochemical cell and comprising:
a second anode formulated to oxidize a second feed stream comprising water to hydrogen ions and dioxygen gas; and
a second cathode formulated to reduce the hydrogen ions into hydrogen gas,
the system being configured to supply the hydrogen ions produced by the second cathode of the at least one second electrochemical cell to the first anode of the at least one first electrochemical cell.

16. The system of claim 15, further comprising an interconnect material between the at least one first electrochemical cell and the at least one second electrochemical cell, the interconnect material formulated to separate carbon dioxide produced at the first electrochemical cell from water produced at the first electrochemical cell.

17. The system of claim 15, wherein the at least one first electrochemical cell is configured as a molten carbonate fuel cell.

18. The system of claim 15, wherein the at least one second electrochemical cell is configured as a proton conducting electrolyzer.

19. The system of claim 15, further comprising two or more modules, each of the modules comprising the at least one first electrochemical cell and the at least one second electrochemical cell coupled to the at least one first electrochemical cell, and a spacer between each of the two or more of the modules.

20. The system of claim 19, wherein each of the modules further comprises an interconnect material between the first electrochemical cell and the second electrochemical cell, the interconnect material configured to separate carbon dioxide produced at the first electrochemical cell from water produced at the first electrochemical cell.
